(19) United States
(12) Patent Application Publication
(10) Pub. No.: US 2009/0047635 A1
(43) Pub. Date: Feb. 19, 2009

(54) Isoelastic Endodontic Pin

(75) Inventors: Detlef Behrend, Warnemuende (DE); Heinrich Von Schwanewede, Rostock (DE); Klaus-Peter Schmitz, Warnemuende (DE)

Correspondence Address: NORRIS, MCLAUGHLIN & MARCUS, P.A., 875 THIRD AVE, 18TH FLOOR, NEW YORK, NY, 10022, US

(73) Assignee: UNIVERSITAET ROSTOCK, Rostock (DE)

(21) Appl. No.: 11/913,247

(22) PCT Filed: Apr. 26, 2006
(86) PCT No.: PCT/EP06/04258

§ 371 Date: May 8, 2008

(30) Foreign Application Priority Data
May 4, 2005 (DE) 10 2005 021 807.5

(51) Int. Cl. A61C 13/30

(52) U.S. Cl. 433/225

(57) ABSTRACT

An isoelastic endodontic pin for the long-term endodontic restoration of teeth is based on a single-piece, fibre-reinforced plastic base body having deformation zones and at least one zone designed in such a way that it possesses reduced flexural and torsional strength; displacement elements, preferably channels, for a fastening material are located outside these zones.

The invention relates to an isoelastic endodontic pin for the long-term endodontic treatment of teeth on the basis of a single-piece, fiber-reinforced hollow plastic base body 8, the base body 4 having deformation zones, and at least one zone 5 being designed in such a way that it has reduced flexural and torsional stiffness, with displacement elements 6 in the form of channels and/or grooves for a fastening material 2 being located outside said zones on the outer covers 3 of the other zones.

Regarding the medical-technological background, it should be noted that endodontic pins are gaining increasing importance in reconstructing lost coronal tooth substance. This is a clinically established method which has been used in millions of patients worldwide each year. The construction of endodontically treated teeth is a precondition for long-term conservation thereof and for the implementation of a prospective overall therapeutic concept and intended to provide a reliable anchoring for final restoration, conserving healthy hard tooth substance.

The growing demand has led to a rapid development of new materials and adhesive techniques. Traditional principles of treatment are being called into question more and more. The physical properties of dentin are not changed significantly by an endodontic treatment. However, loss of hard tooth substance due to the access cavity, removal of the upper cavum, and pre-bores for root canal pins gives rise to weakening. Both metallic and ceramic root canal pins are space-demanding and largely incapable of increasing the stability of an endodontically treated tooth. Preparation of the root canal to anchor fillings or pins is possible directly after applying the root filling without increasing risk. Due to the risk of fracture and an increased risk of reinfecting the root canals, the dwell time of a temporary treatment, especially in combination with temporary pins, must be kept as short as possible. The failure rates seen in conventional techniques usually used so far must not be underestimated in their significance. They are estimated as being between 5.2 and 13.6% as a consequence of root fractures, pin breaking and loss of retention of pin structures. Furthermore, especially quartz- and fiberglass-reinforced pins are reported to undergo peeling of fibers from the matrix at the surface. Following preparation of a root canal, the latter is first treated with an enclosealer and subsequently filled up with gutta-percha to obtain a final root filling. For root canal filling purposes, a wide variety of classes of materials have been used. Frequently, materials based on epoxide resins have been used. Furthermore, zinc oxide/eugenol as well as glass ionomer cements, but also silicone materials, have been utilized. Root canal pins are employed in those cases where tooth hard substance sufficient for adhesive retention of the structure is no longer present after preparation. Most of the root pins used at present are made of metal or ceramics. However, the material properties of these classes of materials differ strongly from those of tooth hard substance. Non-adapted hardness and elastic modulus of these materials are increasingly deemed responsible for subsequently appearing root fractures. Breaking of pins also represents a frequent reason of failure in such treatments.

To fasten the pins, standard cements are presently used which have been developed primarily for the sector of fastening prosthetic products. To date, such zinc/phosphate, glass ionomer or plastic cements have not been adapted to the peculiarities of adhesive fastening in the area of the root dentin. As a consequence, adhesive failure and the associated loss of retention also represent a main source of error in this sector. The tooth hard substance must be replaced with a stump structure before a crown of metal, ceramics or veneer ceramics can be inserted. To this effect, one basic precondition must be reproducing the material properties of dentin as properly as possible. A wide variety of dental materials, also including fiber-reinforced plastic materials which, being composite materials, show a significantly more favorable potential than metals and ceramics, are used for this purpose. These include e.g. silver-reinforced glass ionomer cements or methacrylate-based plastic filling materials. As can be seen from the above compilation, a wide variety of combinations of various classes of materials are presently utilized for the structure of an endodontically treated tooth, which frequently do not precisely meet the peculiarities of a particular field of use. Moreover, complications frequently arise due to the incompatibility of the different materials. Another precondition for optimum long-term functionality is absence of additional damage of the root canal as a result of implanting.

Root pins for a tooth are known from the literature, e.g. those having a threaded shaft (DE 34 46 330 A1 and DE 34 27 172 A1) or pins with a threaded region in the middle of the pin (EP 0 786 237 A1) or with a cutting thread (EP 0 484 947 B1 and EP 0 336 082 A2). One essential drawback of such pins is the notch effect in the dentin caused by the turns of the thread and, as a consequence, an increased risk of tooth root fracture. Furthermore, e.g. tapering two-component root pins have been described (DE 33 16 785 A1), or root pins having an elastic modulus gradient or varying ductility and flexural stiffness (DE 695 02 965 T2 and DE 37 41 847 C2). These are composite pins whose component parts each have different material properties. In addition, all of the well-known endodontic pins involve problems because they have high axial stiffness.

The intention of the invention is therefore to provide a form of a pin which has biomechanically optimized structural compatibility and can be handled safely by the dentist. This requires adequate selection of materials and constructional design which, given a demanded minimum strength, make it possible to follow even curvatures in a root canal, so as to achieve gentle incorporation of a pin without apparent destruction of the dentin structures.

The invention is therefore based on the object of developing an endodontic pin which is isoelastic and capable of adapting to the curvature of a root canal. Its structure should be such that insertion can be effected with conservation of the dentin to the largest possible extent.

The object of the invention is accomplished with the characterizing features of claim 1. According to the invention, an isoelastic endodontic pin made of an integrated fiber-reinforced plastic base body is provided, which, owing to the presence of zones with reduced flexural and torsional stiffness, makes it possible to follow even those root canal curvatures that are determined by the individual anatomy. Other advantageous embodiments of the invention are illustrated in the subclaims and will be explained in more detail below, together with the description of a preferred embodiment and with reference to the drawings.

The endodontic pin of the invention has a single-piece base body 4 made of a hollow fiber-reinforced plastic matrix 8. According to the invention, the base body 4 has deformation zones, at least one zone 5 being designed in such a way that it has reduced flexural and torsional stiffness. Outside said at least one zone 5 with reduced flexural and torsional stiffness, there are axially extending displacement elements 6 for a fastening material 2 in the form of channels and/or grooves, located in the outer covers 3 of the zones with high flexural and torsional stiffness. This preferred design of the outer cover, which is provided with a gel coat and thereby prevents peeling of the reinforcement fibers in case of mechanical stress, allows displacement of the fastening material when using the pin according to the invention. In a preferred fashion, one or more channels are incorporated which ensure displacement of fastening cements. In a preferred embodiment, axial displacement grooves are additionally present in the marginal area to reduce the hydraulic effect during insertion into the fastening material. In a preferred embodiment of the endodontic pin, the base body consists of alternating zones of high and reduced flexural and torsional stiffness and, depending on the length of the pin, at least two zones with reduced flexural and torsional stiffness are present.

The base body 4 preferably comprises a hollow plastic matrix 8 having a reinforcement of organic and/or mineral fibers and/or filler particles. In a preferred fashion the matrix 8 is a biocompatible organic polymer and preferably made of epoxide resin, acrylic or polyester resins such as methyl methacrylates. Other biocompatible materials such as Ormocere®, polyimides or polyether ether ketones can also be used.

The matrix 8 preferably has a reinforcement of chopped fibers and/or a tubular knitted fabric reinforcement 9, which can be present in a single- or multilayer form. In a preferred fashion, carbon tubular knitted fabrics or carbon fibers, silanized glass fibers and/or ceramic fibers are employed, the fibers being incorporated in accordance with the main stress direction.

The selection of the components is crucial to the overall behavior of fiber-reinforced plastics. The properties of the reinforcing fibers surpass those of conventional materials in many respects. It is important to utilize the potential of the fibers to the largest possible extent. This is done by achieving a fiber volume proportion as high as possible (as compared to the binding resin system), with specific orientation of the fibers. One preferred feature is incorporation of the fiber reinforcement in the form of hose-shaped tubular knitted fabrics to prevent splicing of single fibers from the matrix, especially under mechanical load. In a preferred fashion the endodontic pin of the invention is produced using microsystem injection molding in multi-cavity molds.

More specifically, the fiber and filling materials are present in the matrix in a total amount of 50 to 90 wt.-%. Preferred filling materials are e.g. nanodispersed materials and/or X-ray contrast media to improve or achieve X-ray opacity. The matrix preferably contains carbon nanotubes, hydroxylapatite, SiO₂, nanodispersed Ag, CeO, SnO₂, WO₃.

Particularly preferred is an endodontic pin having the following structure: located inside and above a first carbon knitted tube 9 is a polymer matrix of methyl methacrylate, comprising hydroxylapatite 10, X-ray contrast medium 11 and nanodispersed filling materials 12, followed by another tubular knitted carbon fabric 9. The latter is followed by the matrix 8, comprising hydroxylapatite crystals 10, and another tubular knitted carbon fabric 9. Similarly, the matrix 8 that follows contains hydroxylapatite 10, X-ray contrast medium 11 and nanodispersed filling materials 12. The outer cover 3 includes channels 6 to displace the fastening material 2.

In another embodiment of the invention the base body 4 of the endodontic pin is provided with a fitting head 7 attached in positive or non-positive connection, a special application instrument for safe insertion being available, which has a semicircular recess in circumferential negative contour of the fitting head for positive temporary fitting thereon.

The isoelastic endodontic pin according to the invention is excellently suited for endodontic long-term treatment of teeth. Owing to the design of the base body 4 with the biocompatible plastic matrix 8 preferably used, which has a reinforcement of organic and/or mineral fibers and/or filler particles 9, 10, 11, 12, and said zones of reduced flexural and torsional stiffness 5 incorporated in the base body 4, and said displacement elements 6 for a fastening material 2, located outside said zones in the outer cover 3, the pin according to the invention can be incorporated without causing unnecessary stress on the dentin 1.

Particularly preferred embodiments of the invention can be inferred from the enclosed figures.

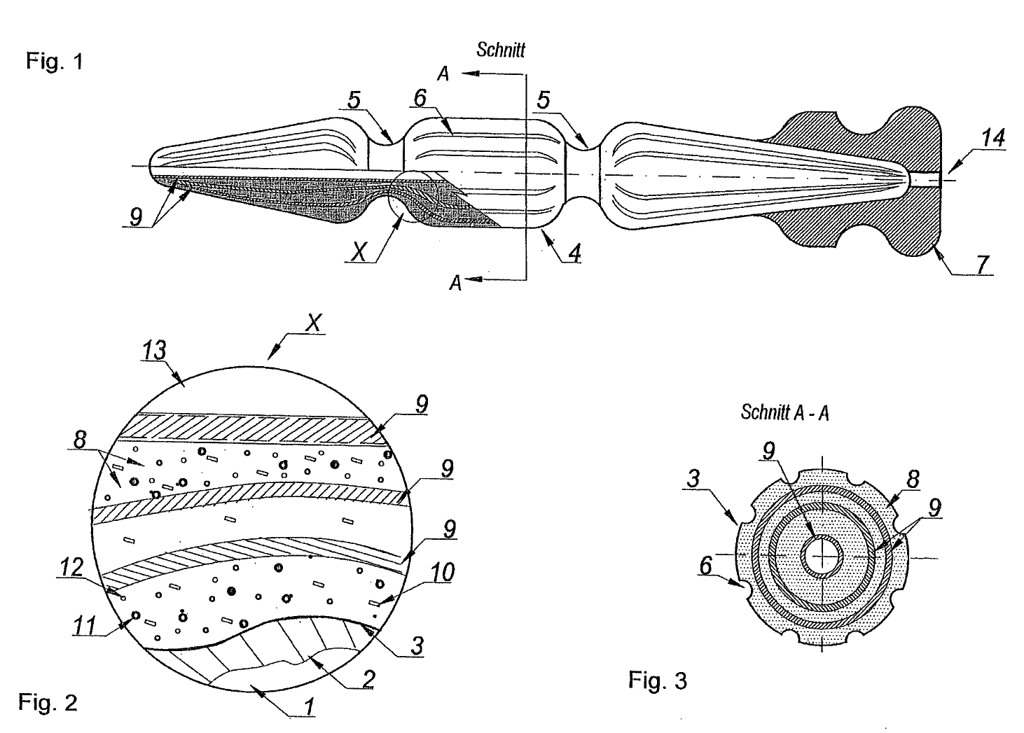

FIG. 1 on top shows a side view of the base body of an inventive isoelastic endodontic pin 4 in the state prior to insertion, which has two zones of reduced flexural and torsional stiffness 5, as well as three layers of reinforcement fibers in the form of a tubular knitted fabric 9, a plurality of displacement channels 6, and a fitting head 7 with vent hole 14, the fitting head being molded or fitted on the endodontic pin via non-positive plug-in connection. X shows the area of transition—in the form of a partial section—from a zone with reduced flexural and torsional stiffness to the base body.

FIG. 2 on the left is an enlarged detail from FIG. 1 on top (detail X).

FIG. 3 on the right shows the cross-section A-A from FIG. 1 on top.

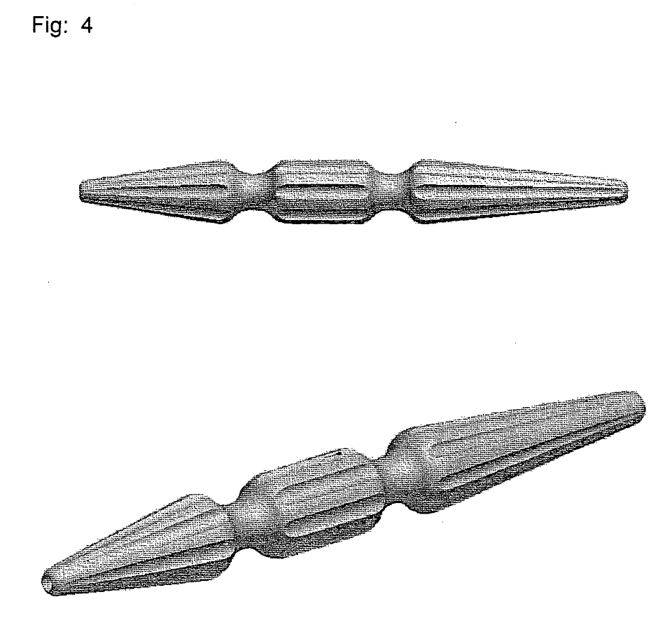

FIG. 4 shows a preferred inventive pin in 3D representation.

The embodiments illustrated above represent preferred variants.

### REFERENCE LIST

1 Dentin
2 Fastening cement
3 Outer cover (gel coat)
4 Base body of the isoelastic endodontic pin
5 Zones of reduced torsional and flexural stiffness
6 Displacement channels
7 Fitting head
8 Plastic matrix
9 Reinforcement fibers in the form of a tubular knitted fabric
10 Hydroxylapatite crystals
11 X-ray contrast particles
12 Nanodispersed filling materials
13 Cavity
14 Vent hole

1. An isoelastic endodontic pin which follows the curvature of a root canal, comprising
a) a single-piece base body (4) made of a hollow fiber-reinforced plastic matrix (8), which body consists of
b) alternating zones of high flexural and torsional stiffness and at least one zone of reduced flexural and torsional stiffness (5),
c) said zones with high flexural and torsional stiffness having axially extending displacement elements (6) in the form of channels and/or grooves on their outer covers (3) to displace a fastening material (2) within the root canal.

2. The endodontic pin according to claim 1, characterized in that the base body (4), depending on the length thereof, has at least two zones with reduced flexural and torsional stiffness (5).

3. The endodontic pin according to claim 1 or 2, characterized in that the hollow plastic matrix (8) has a reinforcement made of organic and/or mineral fibers and/or filler particles.

4. The endodontic pin according to any of claims 1 to 3, characterized in that the hollow matrix (8) consists of a biocompatible organic polymer, preferably epoxide, acrylic or polyester resin.

5. The endodontic pin according to any of claims 1 to 4, characterized in that the reinforcement in the matrix is a chopped fiber and/or tubular knitted fabric reinforcement (9) which is present in a single- or multilayer form.

6. The endodontic pin according to claim 5, characterized in that the fibers are carbon fibers, silanized glass fibers and/or ceramic fibers, preferably tubular knitted carbon fabrics or carbon fibers, incorporated in accordance with the main stress direction, preferably in the form of hose-shaped tubular knitted fabrics.

7. The endodontic pin according to any of claims 1 to 6, characterized in that nanodispersed materials and/or X-ray contrast media are incorporated as filling materials.

8. The endodontic pin according to any of claims 1 to 7, characterized in that carbon nanotubes, hydroxylapatite, SiO₂, nanodispersed Ag, CeO, SnO₂, WO₃ are present as filling materials.

9. The endodontic pin according to any of claims 1 to 8, characterized in that the fibers and filling materials are present in the matrix in an amount of 50 to 90 wt.-%.

10. The endodontic pin according to any of claims 1 to 9, characterized in that the pin is joined with a fitting head design (7), a special application instrument for safe insertion being available, which has a semicircular recess in circumferential negative contour of the fitting head for positive temporary fitting thereon.

11. The endodontic pin according to any of claims 1 to 10, characterized in that it is produced using microsystem injection molding.
